(19) United States
(12) Patent Application Publication
(10) Pub. No.: US 2020/0316586 A1
(43) Pub. Date: Oct. 8, 2020

(54) ACOUSTIC TWEEZERS

(71) Applicants: CENTRE NATIONAL DE LA RECHERCHE SCIENTIFIQUE, PARIS (FR); UNIVERSITÉ DE LILLE, LILLE (FR); ECOLE CENTRALE DE LILLE, VILLENEUVE D'ASQ (FR); SORBONNE UNIVERSITE, PARIS (FR)

(72) Inventors: Antoine RIAUD, LA ROCHE SUR YON (FR); Jean-Louis THOMAS, MONTGERON (FR); Michaël BAUDOIN, LEZENNES (FR); Olivier BOU MATAR-LACAZE, SAINT-AMAND-LES-EAUX (FR)

(21) Appl. No.: 16/304,241

(22) PCT Filed: May 22, 2017
(86) PCT No.: PCT/EP2017/062219

§ 371 Date: Nov. 23, 2018

(30) Foreign Application Priority Data
May 24, 2016 (EP) 16305601.3

(51) Int. Cl. B01L 3/00; G01N 29/24; G01N 29/02

(52) U.S. Cl. CPC B01L 3/50273; G01N 29/2462; G01N 29/02; G01N 2291/0423; B01L 2400/0436; G01N 2291/101; G01N 2291/022; G01N 29/2437

(57) ABSTRACT

An electroacoustic device includes at least one precursor wave transducer. The at least one precursor wave transducer includes a piezoelectric substrate, and first and second electrodes of inverse polarity arranged on the substrate and configured to generate in the substrate a precursor ultrasonic surface wave which is unfocused. When a fluid medium is acoustically coupled with the electroacoustic device, the precursor ultrasonic surface wave propagates as a volume acoustic wave into the bulk of the fluid medium and focuses therein.

The present invention relates to electroacoustic devices notably for manipulating objects which size is less than 10⁻² m, immersed in a fluid medium, preferably a liquid medium, and in particular having a lower density and/or being softer than the fluid medium.

The selective manipulation of nano-sized and micro-sized objects is a complex operation in various technical domains, such as cellular biology, microfluidic, nano- and micro-sized system assembly. Manipulation might be performed using a tool, for instance tweezers or a micropipette. The object is then manipulated through displacement of the tool. Such a manipulating method, which is generally named “direct contact” method, is not desirable, in particular when the object is soft, or tacky, or even brittle. Furthermore, it may alter the manipulated object. Last, the introduction of the tool in a system wherein the object is located may modify the properties of the system. For instance in case the object is submitted to an electromagnetic field, introducing the tool might create a disturbance of said field. It can also introduce some pollution. In case the system is a biological medium comprising cells, the cell behavior can be modified by the introduction of the tool.

Alternative contactless methods have been developed, such as dielectrophoresis, magnetophoresis, or optophoresis, also named “optical tweezers” method. However, all these techniques have major drawbacks. For instance, dielectrophoresis depends on the object polarizability and requires installing electrodes in the vicinity of the object to be manipulated. Magnetophoresis requires grafting of markers onto the object. Optophoresis may be used with or without grafting but is limited to very small forces by the significant heating and photo-toxicity inherent of this method.

Another method has been developed, named “standing wave acoustophoresis”, which consists in implementing surface acoustic waves (SAW) generated in a substrate for manipulating an object lying or overlapping the substrate.

U.S. Pat. No. 7,878,063 B1 describes an electroacoustic device comprising a substrate and three pairs of interdigitated transducers on the substrate. Each pair of transducer defines an acoustic path for propagating a surface acoustic wave generated by the transducers. The three acoustic paths intersect, thus creating a center region for detecting biological species;

WO 2013/116311 A1 discloses an apparatus for manipulating particles comprising a pair of variable frequency interdigitated transducers and a channel defined on a substrate, disposed asymmetrically between the transducers.

WO 2015/134831 describes an acoustic apparatus including a first interdigitated transducer arrangement to generate a first acoustic wave and a second interdigitated transducer arrangement to generate a second acoustic wave in a non-parallel direction relative to the first acoustic wave, and a manipulation region at least partially defined by an interference pattern at least partially formed by interaction between the first acoustic wave and the second acoustic wave. The article “Fast acoustic tweezer for the two-dimensional manipulation of individual particles in microfluidic channels”, S. B. Q. Tran, P. Marmottant and P. Thibault, Applied Physics Letters, American Institute of Physics, 2012, 101, pp.114103, describes a device comprising four interdigitated transducers provided on a substrate at a regular spacing around a central zone. Each transducer generates a standing surface acoustic waves. Implementation of the device provides displacement of a particle in the central zone.

US 2013/0047728 A1 teaches an apparatus comprising an ultrasound source for providing a variable ultrasound signal within a region of interest, and a controller connected to the ultrasound source such that it provides a control signal to the ultrasound source. The variable ultrasound signal creates a pressure field within the region of interest, the shape and/or position of which can be altered by changing the control signal input to the ultrasound source such that a particle within the region of interest will move in response to changes in the pressure field. However, the apparatus of US 2013/0047728 A1 is configured for generating bulk acoustic wave. As a consequence, it requires components of large size which prevent from any use on lab-on-chips. In addition, it is not adapted to generate any surface acoustic wave.

All the known standing wave acoustophoresis methods consist in generating standing acoustic waves for manipulating objects. However, the selectivity of these methods is limited. In particular, all objects do move toward either the nodes or anti-nodes of the waves. As a consequence, the standing wave acoustophoresis methods do not allow the selective manipulation of an object independently from its neighbors.

Furthermore, U.S. Pat. No. 4,453,242, US 2010/0219910, US 2009/01114798 and the article “Subwavelength focusing of surface acoustic waves generated by an annular interdigital transducer”, V. Laude et al., Applied Physics Letters , Volume 92, 094104 (2008) teach devices for generating in a substrate on which electrodes are arranged surface acoustic waves which are focused in the substrate.

Therefore, there is a need for an electroacoustic device and for a method for manipulating at least one object that overcome at least some of the drawbacks of the techniques of the prior art.

According to a first aspect, exemplary embodiments of the invention relate to an electroacoustic device comprising at least one precursor wave transducer comprising:
a piezoelectric substrate,
first and second electrodes of inverse polarity arranged on the substrate and configured to generate in the substrate a precursor ultrasonic surface wave which is unfocused,

wherein

when a fluid medium, preferably a liquid medium, is acoustically coupled with the electroacoustic device, the precursor ultrasonic surface wave propagates as a volume acoustic wave into the bulk of the fluid medium and focuses therein.

A wave that becomes focused, so-called focused ultrasonic wave, propagates towards a spatial point where interferences lead to a maximum of the wave amplitude. An ultrasonic wave can focus in an isotropic substrate and/or in an anisotropic substrate.

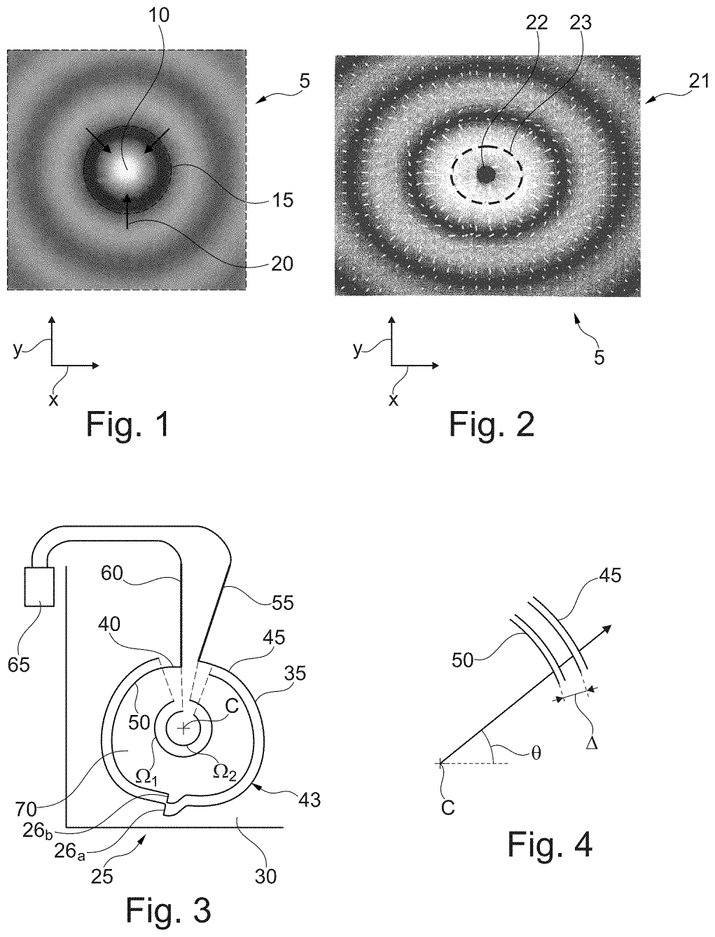

FIG. 1 illustrates schematically the amplitude 5 of a 2D focused ultrasonic wave along directions X and Y. A focused ultrasonic wave comprises an area 10 of high amplitude, generally named “bright spot” encircled by a concentric ring 15 of low amplitude, generally named “dark ring”, illustrated in dashed line in FIG. 1. The bright spot is an area of high radiation pressure whereas the dark circles are zones of low radiation pressure. Therefore, an object less dense and softer than the fluid medium where it is embedded, located on the dark circle is attracted by the bright spot as indicated by the arrows 20 on FIG. 1, as soon as its size is substantially equal or smaller than the fundamental wavelength of the acoustic wave. The object is then entrapped by the bright spot.

As compared to the devices according to the prior art, for instance performing standing wave acoustophoresis, the invention provides several advantages. First, it enables to easily manipulate objects less dense and/or softer than the fluid medium which embeds them. Manipulation of bubbles or soft cells for instance can thus be performed. Second, the electroacoustic device according to the invention is easy to implement, since it can provide manipulation of an object with only a single precursor SAW transducer. It may also be powered with a single low cost powering system. In addition, it does not require any specific setting of the precursor SAW transducer as compared to the prior art, where every transducer of the set of transducers has to be set precisely so that the interferences of the SAWs generated by the transducers result in a radiation pressure field capable of object manipulation. Moreover, the invention is not limited by any substrate property with regard to SAW propagation. In particular, the substrate is preferably anisotropic. Further, the electroacoustic device can be tuned to a wider range of object sizes than devices of the prior art. In particular, the device can apply larger forces than optophoresis devices on a same sized object without destroying it. In the present specification, a surface acoustic wave (SAW) is considered to have a frequency ranging between 1 MHz and 10000 MHz. The wording “surface acoustic wave” and “surface ultrasonic wave” are considered here as equivalent.

The electroacoustic device according to the first aspect of the invention may further present one or more of the following optional features:
The fluid medium is a liquid medium, preferably comprising an object embedded in a solvent;
the ratio of the distance separating a focalization plane where the volume acoustic wave focuses and a substrate surface on which the first and second electrodes are arranged, to a fundamental wavelength of the precursor ultrasonic surface wave is greater than 10, said distance being measured perpendicularly to the substrate surface;
the electroacoustic device comprises a support overlapping the substrate, acoustically coupled thereof and made of at least one material different from a substrate material, such that when the fluid medium is provided on the support, the volume acoustic wave propagates in the support before reaching the fluid medium;
the support comprises a stacking of acoustically coupled layers;
the support has a thickness, measured along a direction perpendicular to the substrate, greater than 10 times the fundamental wavelength of the precursor ultrasonic surface wave; as an example, it is greater than 100 μm and less than 1000 μm;
the support comprises a material chosen among a glass and a polymer, in particular a thermoplastic, most preferably polymethylmethacrylate (PMMA), preferably the support comprises a glass;
the first and second electrodes comprise respective first and second tracks, each drawing a line defined by the equation

$$R ( Θ ) = \frac{{ϕ}_{0} - ω {μ}_{0} ( Θ ) + α ( \overline{ψ} ( Θ ) ) - \frac{π}{4} sgn ( {h}^{′′} ( \overline{ψ} ( Θ ) , Θ ) )}{ω {s}_{r} ( \overline{ψ} ( Θ ) ) cos ( \overline{ψ} ( Θ ) - Θ )}$$

wherein:
   R(θ) is the polar coordinate of the line, from a center C, with respect with the azimuthal angle θ,
   φ₀ is a free parameter,
   in particular, in order for adjacent tracks of first and second electrodes to follow different lines, different φ₀ can be set, the difference between them being preferably ranging between 3.0 and 3.3, even preferably equal to π;
   when the electroacoustic device comprises a plurality of tracks of first and respective second electrodes, φ₀ is preferably incremented between each pair of adjacent tracks by an increment ranging between 6.0 and 6.6, preferably equal to 2π;
   μ₀(θ) is given by:

$${μ}_{0} ( Θ ) = {\sum }_{i = 1}^{n} {s}_{z}^{( i )} ( Θ ) ( {z}_{i} - {z}_{i - 1} )$$

where z₀ is the height of the interface between the substrate and the support, zₙ is the height of the focal plane in the fluid medium, and zᵢ with i≥1, n>1 being the height of an interface separating two consecutive layers in case the support comprises a stacking of acoustically coupled layers, μ₀(θ)=0 in case of the absence of stacked layers
h″(ψ̅) is

$$\frac{{\partial }^{2}}{\partial {ψ}^{2}} [ {s}_{r} ( ψ ) cos ( ψ - Θ ) ]$$

evaluated at ψ=ψ̅ where ψ̅ depends on Θ as follows:

$$\overline{ψ} ( Θ ) = Θ + atan 2 ( \frac{{s}_{r}^{′} ( Θ )}{\sqrt{{s}_{r}^{′ 2} ( Θ ) + {s}_{r}^{2} ( Θ )}} , \frac{{s}_{r} ( Θ )}{\sqrt{{s}_{r}^{′ 2} ( Θ ) + {s}_{r}^{2} ( Θ )}} )$$

sᵣ (ψ) is the wave slowness on the surface plane of the substrate in the direction of propagation ψ, and s_{z}(ψ) is the wave slowness in the out of plane direction, a wave slowness in a direction i being r or z being computed from the wavenumber kᵢ as sᵣ(ψ)=kᵣ(ψ)/ω: and s_{z}(ψ)=k_{z}(ψ)/ω
sᵣ′(ψ) is the derivative of sᵣ(ψ) in respect to the direction of propagation,
α(ψ) is the phase of the vertical motion of the wave propagating in direction ψ versus the associated electric field;
the radial step (Δ), between adjacent first and second tracks is comprised between 0.48 λ and 0.52 λ, preferably equal to λ/2, λ being the fundamental wavelength of precursor ultrasonic surface wave;
the first and second electrodes comprise respective first and second tracks, each following a closed line;
the first and second tracks comprise two portions separated by a tier; in particular, notably when a direction where the piezoelectric coupling of the substrate vanishes, the tier is located along said direction, and preferably the portions of the tracks are aligned with the tier;
the first and the second electrode comprise respective first and second power terminals to which the first and second track are electrically connected;
the first and second electrodes comprise a plurality of respective first and second tracks;
a set consisting of first and second tracks surrounds, at least partially, preferably substantially completely a central zone;
when observed from the central zone, the first and second tracks have on more than 50%, preferably on more than 80% of their length, a concave shape.
the at least one precursor wave transducer is interdigitated;
the at least one precursor wave transducer is covered by a protective coating, preferably comprising silica;
the support is made at least partially of a non-opaque and preferably transparent material;
the support is made of a non-piezoelectric material;
the support is made of an isotropic material with respect to the propagation of an ultrasonic wave;
the support comprises a material chosen among a glass and a polymer, in particular a thermoplastic, most preferably polymethylmethacrylate (PMMA);
the support comprises glass;
the electroacoustic device comprises a layer made of a coupling fluid sandwiched in between the substrate and the support;
the electrodes of the at least one precursor wave transducer are sandwiched in between the substrate and the support, or at least a part of the substrate is sandwiched in between the support and the electrodes of the precursor wave;
the at least one precursor wave transducer is configured for generating a precursor surface acoustic wave such that the radius of the bright spot influence zone of the focused volume acoustic wave in the fluid medium ranges between 0.1 λ, and 0.7 λ, preferably between 0.2 λ and 0.55 λ, λ being the wavelength of the focused volume acoustic wave; the “radius of the bright spot influence zone” is defined by the distance between the location of highest amplitude in the bright spot and the by the location of minimum of amplitude of the first dark ring, as observed for instance in FIG. 1;
the substrate is a plate having a thickness greater or equal than 500 μm;
the electroacoustic device comprises a base, preferably made of a non-piezoelectric material, on which the substrate is disposed;
the base is made at least partially of a non-opaque, preferably a transparent material, notably made of glass;
the substrate is in the form of a layer deposited onto the base, the layer thickness being less than λ/10, λ being the fundamental wavelength of the precursor ultrasonic surface wave;
the base is part of an objective of a microscope or is part of a device configured to be fixed to an objective of a microscope;
the substrate is made of an anisotropic material, preferably chosen among lithium niobiate, lithium tantalate, quartz, zinc oxide, aluminum nitride, lead titano-zircanate, and their mixtures; preferably, when the substrate is in the form of a layer, the substrate is preferably made of an anisotropic material chosen among zinc oxide, aluminum nitride, lead titano-zircanate and their mixtures;
the substrate is at least partially made of a non-opaque, preferably a transparent material;
the at least one precursor wave transducer is configured to generate a precursor surface acoustic wave whose fundamental wavelength λ ranges between 10⁻⁷ m and 10⁻³ m;
the precursor surface acoustic wave is a generalized Lamb wave or preferably a generalized Rayleigh wave;
the electroacoustic device comprises a second precursor wave transducer which respective first and second electrodes are arranged on the same substrate as the first and second electrodes of the at least one precursor wave transducer, the at least one and second precursor wave transducers being configured for generating in the substrate respective precursor ultrasonic surface waves having different respective fundamental wavelengths;
the electroacoustic device comprises contact brushes in contact with and powering the respective at least one and second precursor wave transducers, in respective first and second arrangements of the device, the device being preferably configured such that the transition from the first to the second arrangement is operated by rotation of the substrate around a pivot;
the contact brushes overlap the first track(s) and/or the second track(s) of the at least one precursor SAW transducer and/or the second precursor SAW transducer;
in case the first and/or second tracks of the at least one precursor SAW transducer and/or the second precursor SAW transducer comprise a tier, the contact brushes overlap the tier(s) of the first track(s) and/or the tier(s) of the second track(s) respectively;
the at least one precursor wave transducer surrounds at least partially the second precursor wave transducer, and is preferably intended to generate the lowest fundamental frequency among the at least one and second precursor wave transducers;
the electroacoustic device comprises a visual marking located in a central zone of the at least one transducer surrounded by the first and second electrodes of said at least one transducer, preferably made of the same material as the first and second tracks;
the electroacoustic device is disk shaped;
the substrate is mounted rotatable on a pivot around a rotation axis;
the electroacoustic device comprises an organ configured for moving the support relatively to the at least transducer, preferably by translation along anyone of two axis both perpendicular, and parallel to the substrate.

Preferably, the first and second electrodes are deposited onto the substrate by photolithography. In particular, a layer of a material comprising chromium or titanium might be deposited onto the substrate before depositing the electrodes in order to improve the adherence of the electrodes on the substrate.

Preferably, the first and second electrodes are made from a metallic material, preferably chosen among gold, silver, aluminum and their mixtures. Aluminum is preferred for applications at frequency higher than 100 MHz. Gold and/or silver are preferred when a good conductivity is required.

The width, measured along a radial direction of the tracks of the first and second electrodes, can be equal. In a variant, the width can be different.

The substrate can be plane or curved.

The electroacoustic device according to the invention can comprise the fluid medium, preferably overlapping the precursor SAW transducer. In particular, the fluid medium can be a liquid droplet.

The fluid medium can comprise a solvent wherein particles are embedded. For instance, the solvent is water. For instance, the particles are cells or colloidal particles.

In an embodiment, the electroacoustic device can further comprise a swirling wave transducer having first and second electrodes of inverse polarity comprising respective first and second tracks provided on the substrate, the tracks spiraling around a same center, and being configured for generating a swirling ultrasonic surface wave in the substrate.

In particular, among the group consisting in the swirling wave transducer, the at least one precursor wave transducer, and if appropriate the second precursor wave transducer, one transducer of said group, preferably the one which is intended to generate the wave having the lowest fundamental wavelength, surrounds at least one of the other transducers of said group.

A swirling surface acoustic wave (SAW) is a wave that propagates spinning around a phase singularity where destructive interferences lead to cancellation of the wave amplitude. A swirling SAW can propagate in an isotropic substrate and/or in an anisotropic substrate.

FIG. 2 illustrates the amplitude 21 of a swirling SAW at the surface of an isotropic substrate along directions X and Y of the substrate. A swirling SAW comprises an area of low amplitude 22, generally named “dark spot” encircled by concentric rings of high amplitude 23, generally named “bright rings”, illustrated in dashed line in FIG. 2. The dark spot is an area of low radiation pressure whereas the bright circles are zones of high radiation pressure. Therefore, a swirling SAW propagating at the surface of a substrate is such that an object being stiffer and denser than the liquid medium lying for instance on the substrate and located on a bright circle is attracted by the dark spot of the swirling SAW as indicated by the arrows on FIG. 2, as soon as its size is substantially equal or smaller than the fundamental wavelength of the swirling SAW. The object is entrapped by the dark spot.

The swirling SAW transducer preferably comprises first and second electrodes of inverse polarity comprising respective first and second tracks provided on the substrate, the first and second tracks of the swirling SAW transducer spiraling around a same center, the swirling SAW transducer being configured for generating a swirling ultrasonic surface wave in the substrate.

The swirling SAW transducer comprises may further present one or more of the following optional features:
a set consisting in the first and second electrodes of the swirling SAW transducer surrounds entirely the center, and define a central zone;
the first track and/or the second track extend(s) of the swirling SAW transducer over more than 90°, preferably over more than 180°, even preferably over more than 270° around the center;
each of the first and second tracks of the swirling SAW transducer spirals along a line defined by the equation (2)

$${R}^{′} ( Θ ) = \frac{{ϕ}_{0} - ω {μ}_{0} ( Θ ) + α ( \overline{ψ} ( Θ ) ) - \frac{π}{4} sgn ( {h}^{′′} ( \overline{ψ} ( Θ ) , Θ ) ) - l Θ}{ω {s}_{r} ( \overline{ψ} ( Θ ) ) cos ( \overline{ψ} ( Θ ) - Θ )}$$

wherein |1|>0 is an integer number, and the terms of equation (2) are the same as the ones defines here above for equation (1). Equation (2) differs notably from equation (1) by the presence of the term lΘ, 1 being the order of the swirl.
the radial step between adjacent first and second tracks of the swirling SAW transducer is comprised between 0.48 λ′ and 0.52 λ′, preferably equal to λ′/2, λ′ being the fundamental wavelength of the swirling ultrasonic surface wave;
each of the first and second tracks of the swirling SAW transducer runs along at least one revolution;
the first and the second electrode of the swirling SAW transducer comprise respective first and second power terminals to which the first and second track are electrically connected;
the first and second electrodes of the swirling SAW transducer comprise a plurality of respective first and second tracks;
the swirling SAW transducer is interdigitated;
two consecutive first, respectively second tracks of the swirling SAW transducer are separated, along at least one radius, by at least two consecutive second, respectively first tracks;
the swirling SAW transducer is covered by a protective coating, preferably comprising silica;
the swirling SAW transducer is acoustically coupled with the support such that a swirling ultrasonic surface wave generated in the substrate is transmitted to the support and propagates as an acoustical vortex or a degenerated acoustical vortex in the bulk of the support, preferably for creating a pressure trap to which an object embedded in the fluid medium is submitted and/or to which said fluid medium is submitted;
the swirling SAW transducer is configured for generating a swirling surface acoustic wave such that the radius of the dark spot influence zone of the swirling surface acoustic wave ranges between 0.1 λ and 0.7 λ, preferably between 0.2 λ and 0.55 λ, λ being the wavelength of the swirling surface acoustic wave; the “radius of the dark spot influence zone” is defined by the distance between the location of lowest amplitude in the dark spot and the by the location of maximum of amplitude of the first bright ring.

Exemplary embodiments of the invention also relate to an optical device comprising the electroacoustic device according to the invention.

The optical device according to the invention may further present one or more of the following optional features:
the optical device is a microscope;
in at least one configuration of the optical device, the at least one transducer of the electroacoustic device is located between an objective of the microscope and the support;
the electroacoustic device is fixed to an objective of the microscope;
the optical device comprises a plurality of objectives, at least two objectives having different magnifications, at least two, preferably all the objectives being each fixed to an electroacoustic device;
an electroacoustic device fixed on an objective of the plurality is different from an electroacoustic device fixed on another objective of the plurality.

Exemplary embodiments of the invention also relate to a method for manipulating at least one object in a fluid medium, comprising:
generating a precursor surface acoustic wave with an electroacoustic device comprising a precursor surface acoustic wave transducer, and
propagating a volume acoustic wave induced by the precursor surface acoustic wave into the fluid medium and focusing said volume acoustic wave therein for creating therein a radiation pressure to which said object is submitted, and manipulating the object through displacement of the precursor wave transducer of the electroacoustic device relative to the fluid medium.

The method for manipulating at least one object in a fluid medium may further present one or more of the following optional features:
the electroacoustic device is according to the invention;
the method comprises propagating the volume waves throughout the bulk of a solid support before they reach the fluid medium;
the precursor wave transducer is part of a device comprising on a single piezoelectric substrate tracks of at least two respective precursor SAW transducers, preferably interdigitated, having different patterns of electrodes;
the device is rotatable about a rotation axis, and the method comprises rotating the device before or after using the transducer;
the method comprises displacing the precursor SAW transducer relative to the medium using at least one electrical actuator;
the device comprises a visual marking located in a central zone of the precursor SAW transducer, preferably made of the same material as the first and second tracks, the method comprising arranging the electroacoustic device such that the visual marking is offset from the object, following by powering the precursor SAW transducer for generating a volume ultrasonic wave in the fluid medium such as to displace the object for it overlaps the visual marking;
the method comprises observing the object with an optical device according to the invention;
the precursor SAW transducer comprises an array of electrode tracks, the method comprising powering the electrode tracks with a single AC source;
the object is a biological material, preferably a cell, the object preferably being label free.

According to a second aspect, exemplary embodiments of the invention relate to an electroacoustic device comprising
a piezoelectric substrate,
at least two electrodes of inverse polarity arranged on the substrate and defining with the substrate a swirling wave transducer, the at least two electrodes comprising respective tracks spiraling around a same center, and being configured for generating a swirling ultrasonic surface wave in the substrate,
at least two further electrodes of inverse polarity arranged on the substrate and defining with the substrate a precursor wave transducer, the at least two further electrodes being configured to generate in the substrate a precursor ultrasonic wave which is unfocused and is different form the swirling ultrasonic surface wave.

The electroacoustic device according to the second aspect of the invention can present at least one of the optional features:
the tracks of the at least two electrodes of the swirling wave transducer surround the tracks of the at least two further electrodes of the precursor wave transducer;
the tracks of the at least two further electrodes of the precursor wave transducer surround the tracks of the at least two electrodes of the swirling wave transducer;
the tracks of the at least two further electrodes of the precursor wave transducer and of the at least two electrodes of the swirling wave transducer are concentric;

The electroacoustic device according to the second aspect of the invention can further comprise at least one, even all, of the features of the electroacoustic device according to the first aspect of the invention.

In the following, unless otherwise stated, the wording “transducer” refers to a precursor SAW transducer, the wording and tracks “electrodes” and “tracks” refer to electrodes and tracks respectively of the precursor SAW transducer.

The invention may be better understood from a reading of the detailed description that follows, with reference to exemplary and non-limiting embodiments thereof, and by the examination of the appended drawing, in which:

FIGS. 1 and 2 illustrate the phase and amplitude of a focused acoustic wave and of a swirling surface acoustic wave respectively,

FIGS. 3, 4 and 9 to 13 illustrate embodiments of an electroacoustic device according to the invention,

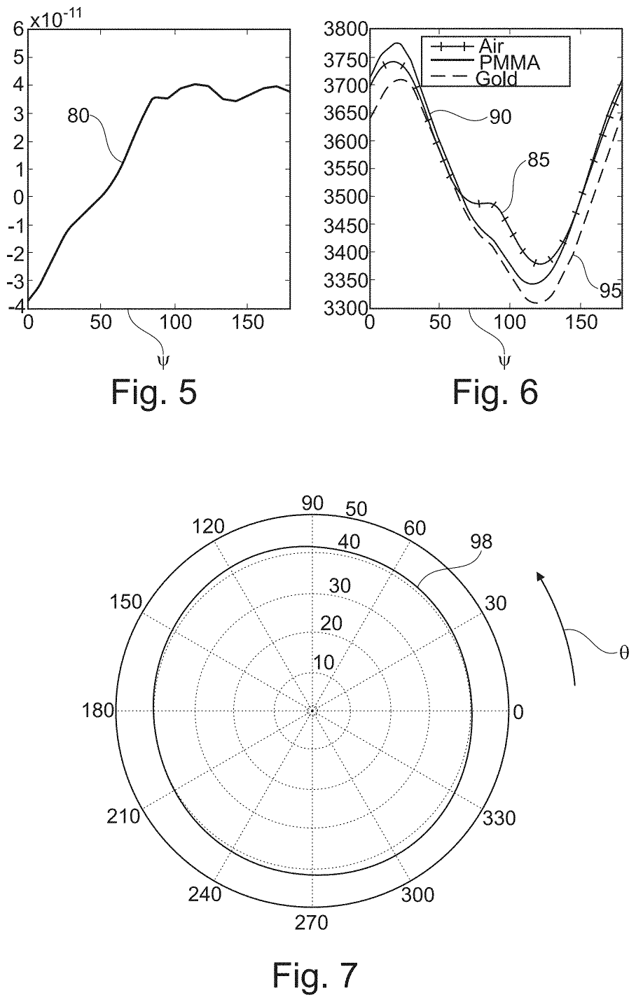

FIG. 5 represents the amplitude of the vertical transverse displacement of a plane front wave in an anisotropic substrate depending on the propagation direction,

FIG. 6 represents the Rayleigh velocity of a plane front wave in an anisotropic substrate depending on the propagation direction at the interface with different media,

FIG. 7 is a 2D graph of the curve of φ₀−ωμ₀,

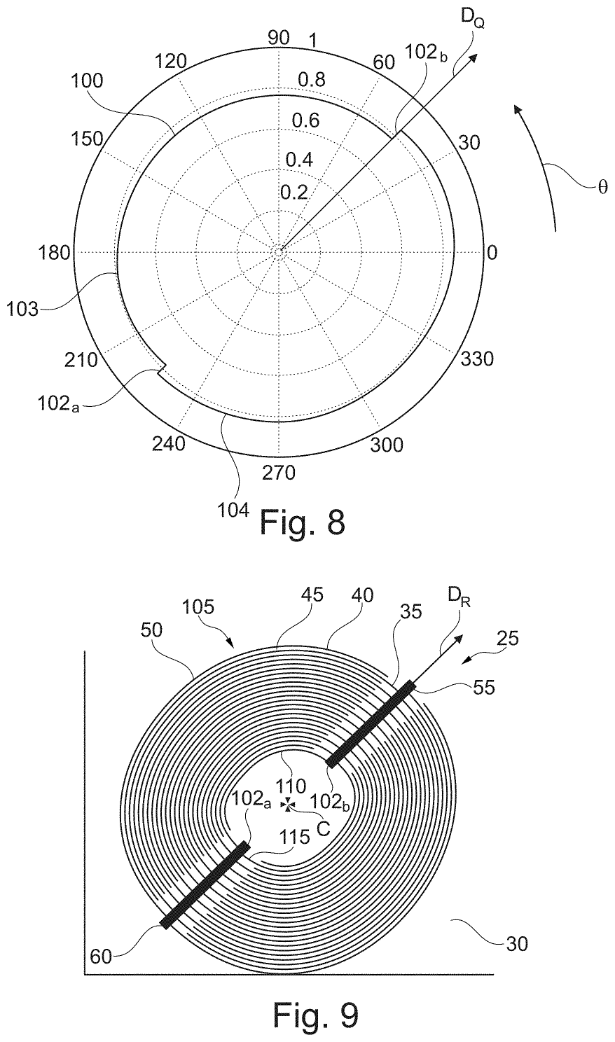

FIG. 8 is a 2D graph of the curve R(θ) used for defining the tracks of the electroacoustic device of FIG. 7,

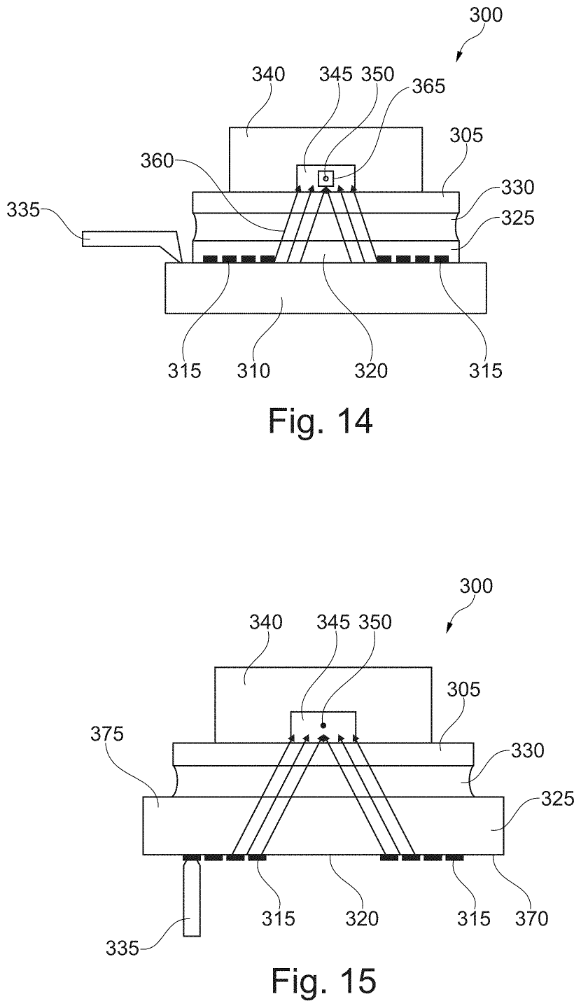

FIGS. 14 to 19 show variants of electroacoustic devices, and

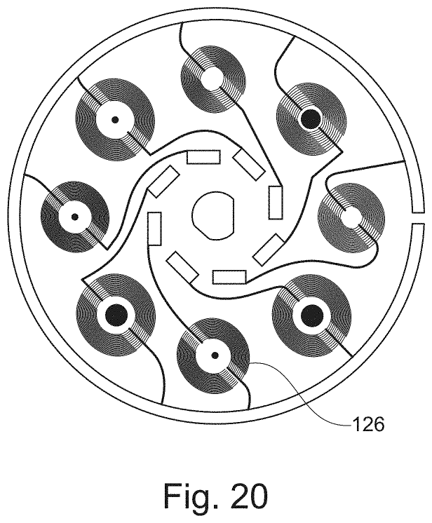

FIG. 20 is a mask for fabrication by photolithography of an electroacoustic device.

In the drawing, the respective proportions and sizes of the different elements are not always respected for sake of clarity.

FIG. 3 illustrates an electroacoustic device 25 according to the invention, comprising a substrate 30 and first 35 and second 40 electrodes of a precursor transducer 43 disposed on the substrate. The first and second electrodes comprise respective first 45 and second 50 tracks which both are curved around a same center C.

When observed from center C, the first and second tracks appear substantially concave.

The first and second tracks extend both over angles Ω₁ and Ω₂ greater than 270° around the center, but over different angular sectors. The angles Ω₁ and Ω₂ may be equal or different.

The first and second electrodes comprise respective first 55 and second 60 terminals for being connected to an electrical power supply 65. The first and second tracks are connected to said respective terminals.

The terminals can be made of the same material as the electrodes and during a same deposition process. As an alternative, they can be made of different materials.

The set consisting of the first and second tracks entirely surround a central 70 zone comprising the center C, as shown in FIG. 3. Thus, elementary SAWs are emitted by almost every angular section covered by the first and second tracks, interfering to generate a precursor SAW in the central zone, that can become focused after being transmitted toward a liquid medium overlapping the substrate.

A explained here above, a support can be disposed in contact with the substrate and the tracks. A fluid medium can be arranged on top of the fluid medium, such as the substrate is located in between the fluid medium and the precursor wave transducer.

The zone in the fluid medium overlapping the substrate where the bright spot of the focused volume acoustic wave develops from the precursor SAW, preferably overlaps the center C.

Furthermore, increasing the number of tracks constitutive of each electrode of the precursor SAW transducer results in an increase of the acoustic power of the precursor SAW.

The fundamental wavelength λ of the precursor SAW is determined by the distance between two successive first and second electrodes. As shown in FIG. 4, the radial step A between two consecutive first and second tracks is preferably equal to λ/2, λ being the fundamental wavelength of the precursor SAW.

Throughout the whole description, and unless stipulated otherwise, the terms “isotropy” and “anisotropy” respectively refer to isotropy and anisotropy with regard to the propagation of an acoustic wave in any material.

In a substrate made of an anisotropic material, the generation of a precursor SAW adapted to transmit and propagate as a focused volume acoustic wave in a fluid medium is complex, since one has to deal notably with direction-dependent wave velocity, coupling coefficient and beam stirring angle. This can modify the way SAW propagating in different directions interfere.

In an anisotropic substrate, the wavelength of a SAW, its velocity and amplitude may depend on the direction along which the SAW propagates.

Furthermore, in case a support is stacked onto the substrate and is acoustically coupled with it, the precursor SAW can be transmitted in the bulk of the support. However, the precursor SAW degenerates at the interface between the substrate and the support, which might prevent the transmitted volume acoustic wave to become focused. The shape of the SAW, i.e. notably its phase and amplitude in different substrate directions, is also modified by any isotropy mismatch between the support and the substrate. In particular, in an embodiment, the substrate is preferably made of an anisotropic material and the support is made of an isotropic material.

Preferably, each of the first and second tracks spirals along a line defined by the equation (1):

$$R ( Θ ) = \frac{{ϕ}_{0} - ω {μ}_{0} ( Θ ) + α ( \overline{ψ} ( Θ ) ) - \frac{π}{4} sgn ( {h}^{′′} ( \overline{ψ} ( Θ ) , Θ ) )}{ω {s}_{r} ( \overline{ψ} ( Θ ) ) cos ( \overline{ψ} ( Θ ) - Θ )}$$

where:
R(θ) is the polar distance coordinate of the line with respect to the azimuthal angle θ from center C;
φ₀ is a parameter freely chosen to determine the center of the spiral; in an electrode comprising successive tracks forming digits, the line of every successive track is preferably obtained by adding a multiple of 2π to φ₀
ω=2πf is the fundamental angular frequency and f is the fundamental frequency of the precursor SAW;
α(Θ) is the phase of the coupling coefficient of the piezoelectric material constitutive of the substrate.
h(ψ, Θ)=sᵣ(ψ)cos(ψ−Θ) where sᵣ(ψ) is the phase slowness of the precursor wave and is defined by sᵣ(ψ)=kᵣ(ψ)/ω, kᵣ(ψ) being the norm of the radial component of the wave vector at angle Θ;
the sign ′ denotes derivation on variable ψ;
function ψ̅(Θ) is defined by the equation

$$\overline{ψ} ( Θ ) = Θ + atan 2 ( \frac{{s}_{r}^{′} ( Θ )}{\sqrt{{s}_{r}^{{′}^{2}} ( Θ ) + {s}_{r}^{2} ( Θ )}} , \frac{{s}_{r} ( Θ )}{\sqrt{{s}_{r}^{{′}^{2}} ( Θ ) + {s}_{r}^{2} ( Θ )}} ) ;$$

and
the correction term μ₀ corrects the SAW degeneration in the bulk of a stacking of support acoustically coupled with the substrate, when the precursor SAW is transmitted from the substrate to the bulk of said support to propagate as a volume wave; in order to synthesize the precursor wave that will degenerate into a focused volume acoustic wave in a fluid medium provided on the support at the desired height zₙ:

$${μ}_{0} ( Θ ) = {\sum }_{i = 1}^{n} {s}_{z}^{( i )} ( Θ ) ( {z}_{i} - {z}_{i - 1} )$$

wherein s_{z}⁽ⁱ⁾(Θ)=√s⁽ⁱ⁾^{²}(Θ)−sᵣ²(Θ) is the phase slowness of the waves in each material (i) of the stacking,

$${s}^{( i )} ( Θ ) = \frac{1}{{c}^{( i )} ( Θ )}$$

being the phase slowness in the material (i) of the stacking, c⁽ⁱ⁾(Θ) being the wave celerity in the material at angle Θ, and
where z₀ is the height of the interface between the substrate and the support, zₙ is the height of the focal plane in the fluid medium, and zᵢ with i≥1, n>1 being the height of an interface separating two consecutive layers in case the support comprises a stacking of acoustically coupled layers, μ₀(θ)=0 in case of the absence of stacked layers. When no material is coupled with the substrate then Θ₀(Θ)=0.

The position of a positive electrode track is defined by selecting the angle φ₀ in equation (1) and the position of the negative electrode track is then defined by the same equation (1) replacing φ₀ by φ′₀=φ₀+π.

As it appears clearly in equation (1), although the pattern of a line a track draws can be adapted to a broad range of substrate material and if appropriate to any support material stacked onto the substrate, it is nevertheless specific to a single set of actuation frequency of the device, material properties and thicknesses.

In particular, the pattern shape relies on the frequency of the precursor SAW propagating in the substrate. In case a support comprising several layers made of different materials is acoustically coupled to the substrate so that a precursor SAW is transmitted and propagates in the volume of the materials of the support as a volume acoustic wave, the pattern shape can depend on the properties of each layer, especially of the material of the layer.

As shown in FIG. 5, the amplitude 80 of a plane front SAW in an anisotropic substrate, for instance in a X-cut lithium niobiate substrate is dependent on the angle ψ of propagation of the wave in the substrate. The substrate anisotropy therefore affects the wave propagation. This coupling might change its sign, resulting in a tier at an angle θ=45° on the R(θ) curve, as it will be detailed here below.

Furthermore, as shown by FIG. 6, the Rayleigh velocity of a plane front SAW at the surface substrate also depends on the direction of propagation of the wave. This dependence is observed whether the substrate surface is free and contacts air (curve 85) or a support, for instance a 2 mm thick polymethylmethacrylate (PMMA) plate (curve 90) or even a gold coating (curve 95) is acoustically coupled with said substrate.

FIG. 7 is a graph representing the correction term φ₀−ωθ₀(Θ), labeled 98, for different values of angle Θ, as indicated along the periphery of the graph. It is required for a precursor SAW propagates in an anisotropic X-cut lithium niobiate substrate, transmitted into a 200 μm thick borosilicate glass plate support (usually referred to as glass coverslip #1) acoustically coupled to the substrate and then into a droplet of water provided onto the support where is becomes focused. Values 10 to 50 along a direction at Θ=70° on the graph indicate, expressed in radians, of the correction term φ₀−ωμ₀(Θ).

FIG. 8 shows the trajectory of a line R(Θ), expressed in mm, and labeled 100, computed from equation (1), for an anisotropic X-cut lithium niobiate substrate. Angles expressed in degrees are regularly indicated at the periphery of the drawing. The graph of the line R(θ) takes into account the evolution of the correction term μ₀(Θ), the amplitude and Rayleigh velocity as illustrated on FIGS. 5 to 7. In FIG. 8, one observes at θ=45° a steep transition 102a-b due to a phase change in the precursor SAW caused by anisotropy of the piezo-acoustic coupling in the substrate. In other words, the first or second track following the line of equation R(θ) comprises two portions 103 and 104 separated by at least one tier 102a-b located along a phase singularity of the precursor SAW, which is located along a zero coupling direction of the piezoelectric substrate. This steep transition is also observed as a tier 26a-26b on any of the first and second tracks of the electrodes of FIG. 3.

FIG. 9 illustrates an electroacoustic device 25 comprising a precursor SAW transducer 105 having first 35 and second 40 electrodes provided on a substrate 30 and comprising a plurality of respective first 45 positive and second 50 negative tracks. The tracks are provided on the X-cut lithium niobiate substrate following equation (1) described here above. The positive tracks are obtained considering an angle φ₀ in equation (1) and the negative tracks are obtained by replacing φ₀ in equation (1) by φ′₀=φ₀+π.

Thus, the first and second tracks comprise the same center C and are distant along a radial direction D_{R} by a radial step equal to λ/2, λ being the fundamental wavelength of the precursor SAW.

As it can be observed, the transducer is interdigitated. The first and second tracks are imbricated the ones with the others.

The electrodes comprise first 55 and second 60 power terminals having the shape of straight lines, which are respectively electrically connected to each of the first and second tracks. The power terminals overlap the steep transitions 102a-b separating the portions of the first, respectively of the second tracks. For instance, the design of the tracks of the device of FIG. 9 following equation (1) is adapted to generate a precursor acoustic wave in the substrate, and to propagate a volume acoustic wave of frequency equal to 10 MHz in a 2 mm thick support made of PMMA provided on top of the transducer and coupled by a layer of silicon oil of a few microns height sandwiched in between the substrate and the support. The silicon oil layer achieves a coupling between the substrate and the support while it does not affect substantially the propagation of the acoustic wave since its thickness is much smaller than the acoustic wavelength. When a fluid medium is provided on top the support, the volume acoustic wave transmits from the support into the fluid medium and becomes focused therein.

The device according to the invention can be such that a set consisting in several tracks of the first electrode, in particular one track 110 as illustrated in FIG. 9, and/or several tracks of the second electrode, in particular one track 115 as illustrated in FIG. 9, running along a single second winding, surrounds entirely the center.

Furthermore, the first and/or the second power terminals and the plurality of first and/or second tracks of the device of FIG. 9 are arranged such that the first, respectively second electrode track, when observed along a direction normal to the substrate has a shape of a fork.

A transducer as illustrated in FIG. 9 can be manufactured according to the following method. A X-cut lithium 1 mm thick niobiate lithium substrate is polished and cleaned, for instance with acetone-isopropyl-ethanol, and then dried for 1 minute at 100° C. A layer of primer, and then of AZ1512HS resin are deposited by centrifugation at 4000 rpm on a substrate face and is annealed at 100° C. for 1 minute. A mask being the positive of the pattern of the electrodes of the transducer is apposed on the resin. FIG. 20 illustrates a mask 126 for preparing an electroacoustic device comprising a plurality of transducers as it will be described latter. The primer is then exposed to an UV radiation. The substrate is then placed in an evaporator in order to deposit a 50 nm thick chromium layer, followed by deposition of a 200 nm gold layer.

The substrate is then dipped into a bath of acetone submitted to ultrasound emission at 80 kHz at a temperature of 45° C. for 10 minutes.

As described previously, the electrodes can be arranged on the substrate such as to account for the distance, measured normally to the substrate surface, of the localization plane where the volume wave surface is intended to become focused. In particular, in case a support overlaps the substrate, said distance can be modified by the support, especially by the height, of the support.

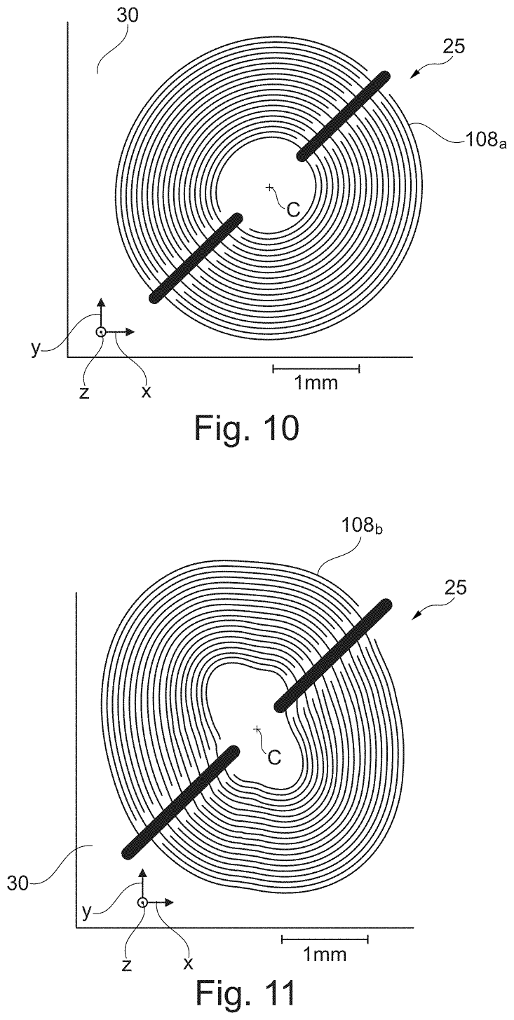

As a matter of illustration, FIGS. 10 and 11 show electroacoustic devices 25 comprising precursor wave transducers 108a-b which both generate precursor SAW having a fundamental frequency of 30 MHz. A support having a thickness, measured along direction Z, perpendicularly to the substrate surface, respectively of 150 μm and 1500 μm, overlaps and is acoustically coupled with the precursor wave transducer illustrated respectively in FIG. 10 and in FIG. 11. The volume acoustic waves transmitted by the respective precursor waves generated by the precursor wave transducers of FIGS. 10 and 11 are both intended to become focused in a liquid medium at the same height, in the fluid medium, from the interface separating the support and the fluid medium.

The difference in the electrode shape between the precursor wave transducers of FIGS. 10 and 11 is notably related to the requirement that the acoustic wave has to travel a longer distance to become focused in the example of FIG. 11 as compared to FIG. 10.

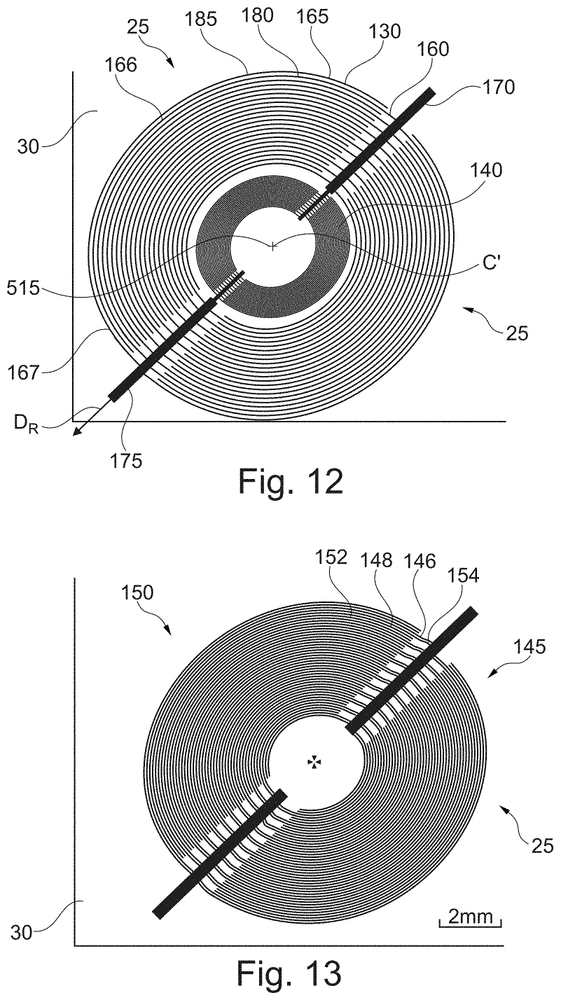

FIG. 12 represents an electroacoustic device 25 comprising a precursor SAW transducer 140 as the one described in FIG. 9 and a swirling SAW transducer 130. The swirling SAW transducer is configured to generate a swirling SAW in the substrate.

The precursor SAW transducer and the swirling SAW transducer share the same substrate 30.

The swirling SAW transducer has first 160 and second 165 electrodes provided on the substrate and comprises a plurality of respective first 166 positive and second 167 negative tracks. The tracks are provided on the X-cut lithium niobiate substrate following equation (2) described here above. The positive tracks are obtained considering an angle φ₀ in equation (2) and the negative tracks are obtained by replacing φ₀ in equation (1) by φ′₀=φ₀+π.

Thus, the first and second tracks comprise the same center and are distant along a radial direction D_{R} by a radial step equal to λ/2, λ′ being the fundamental wavelength of the swirling SAW.

As it can be observed, the swirling SAW transducer is interdigitated. The first and second tracks of the swirling SAW transducer are imbricated the ones with the others.

The electrodes of the swirling SAW transducer comprise first 170 and second 175 power terminals having the shape of straight lines, which are respectively electrically connected to each of the first and second tracks.

As it might be observed, the precursor SAW transducer and the swirling SAW transducer share the same substrate and the same power terminals.

A set consisting in several tracks of the first electrode of the swirling SAW transducer, for instance track labeled 180, running along a single first spiral winding, and/or several tracks of the second electrode of the swirling SAW transducer, for instance track labeled 185, running along a single second spiral winding, surrounds entirely the center.

Furthermore, the first and/or the second power terminals and the plurality of first and/or second tracks of the swirling SAW transducer of FIG. 12 are arranged such that the first, respectively second electrode track, when observed along a direction normal to the substrate has a shape of a fork.

The tracks of the precursor SAW transducer and of the swirling SAW transducer are provided on the substrate following respective lines of equations (1) and (2) as described here above. The parameters of equation (1) are chosen such that the precursor SAW transducer generates a precursor SAW in the substrate at a fundamental frequency of 10 MHz and the swirling SAW transducer generates a swirling SAW in the substrate at a fundamental frequency of 30 MHz, swirling around an axis passing through center C and perpendicular to the substrate.

The swirling SAW transducer as illustrated in FIG. 12 can be manufactured according to the method described here above for depositing the electrodes of a precursor SAW transducer.

The swirling SAW transducer is intended for generating a swirling surface acoustic wave in the substrate which is transmitted and propagates toward the fluid medium, in particular by traveling throughout the support, as an acoustical vortex or a degenerated acoustical vortex induced for creating therein a radiation pressure wherein said object is submitted.

Besides, in FIG. 12, the first and second tracks of the precursor SAW transducer and of the swirling SAW transducer have a common center C′.

An object may be captured either by a focused acoustic wave or a swirling SAW, depending on the object stiffness and density. Consequently, the user of the electroacoustic device of FIG. 12 may switch between powering anyone of the two wave transducers to generate a precursor SAW or a swirling SAW in order to capture an object. The electroacoustic device of FIG. 12 is therefore adapted to manipulate objects having a broader range of mechanical properties than an electroacoustic device comprising a single precursor SAW transducer or a single swirling SAW transducer.

In a variant which is not illustrated, the swirling SAW of FIG. 12 can be replaced by a second precursor SAW transducer such that first and second electrodes of the respective first and second precursor SAW transducers have the same center C′. Preferably, the first and second precursor SAW transducers, having different respective electrode patterns are in intended to generate different respective precursor SAWs. In other words, the SAW generated by the first precursor SAW transducer is different from the SAW generated by the second precursor SAW transducer.

FIG. 13 illustrates an electroacoustic device 25 comprising a precursor SAW transducer comprising two sets 145, 150 of first and second electrodes. The substrate 30 is the same as in examples of FIGS. 9 and 12.

The first set 145 comprises first and second electrodes labeled 146 and 148 and the second set 150 comprises first and second electrodes labeled 152 and 154. Each of the first and second electrodes comprise first and second pluralities of tracks which follow a line of equation (1). Thus the precursor SAW transducer of the electroacoustic device illustrated in FIG. 13 is adapted to generate precursor SAWs operating at two fundamental frequencies of 10 MHz and 30 MHz respectively. The size of the object captured by the focused volume acoustic wave depends on the wavelength and therefore of the frequency of the surface wave vibrations. The transducer of FIG. 13 generated precursor SAWs having two respective working frequencies (10 and 30 MHz) and therefore is suitable to trap objects of different sizes, for instance of small or large size simply by switching the frequency of actuation. It might also be suitable for entrapping and/or manipulating objects located at different heights in the fluid medium.

In particular, the electroacoustic device is such that two consecutive first tracks along a radial direction are alternate in the radial direction with two consecutive second tracks of the second electrode.

FIG. 14 illustrates an electrical device 300 according to the invention comprising a precursor SAW tranducer and a support 305 overlapping the substrate 310. The support can overlap the electrodes 315 or it can only overlap the central zone 320.

Furthermore, the support can be removable from the electroacoustic device.

The tracks of the precursor SAW transducer can be located in between the substrate and the support.

The support is preferably chosen among a glass and a polymer, preferably a thermoplastic, most preferably polymethylmethacrylate (PMMA). Preferably, the support is made of material comprising glass.

Preferably, the material of the support is isotropic. Preferably, it is not piezoelectric.

In order to protect the tracks from friction by the support and prevent from damage, the transducer is at least partially, preferably totally covered by a protective coating 325, preferably comprising silica. Preferably, the protective coating thickness is less than λ/20, λ being the fundamental wavelength of the precursor SAW. Thus, the transmission of the precursor SAW is unaffected by the protective coating.

Preferably, for optimum transmission of acoustic waves, a coupling fluid layer 330, preferably made of a silicon oil, is sandwiched in between the support and the substrate. Preferably, the thickness of the coupling fluid layer is less than λ/20, λ being the fundamental wavelength of the precursor SAW. Thus, the transmission of the precursor SAW is unaffected by the coupling fluid layer. Silicon oil is preferred since it has a low dielectric constant and since it does not molder. Furthermore, the coupling fluid allows easy displacement of the support relative to the substrate.

Electric brushes 335 are in contact with the electrodes for supplying power to the transducer.

As illustrated, the electroacoustic device can also comprise a cover 340 provided onto the support, and comprising a groove 345 defining a chamber, preferably made of PDMS, for instance having the shape of a microchannel configured for housing a fluid medium, in particular a liquid medium, comprising an object 350 to be manipulated.

Preferably, in the embodiment of FIG. 14, the precursor SAW is a generalized Rayleigh wave. Preferably, the thickness of the substrate is greater than 10 λ, λ being the fundamental wavelength of the precursor SAW.

As described previously, the pattern of the tracks of the electrodes of the precursor SAW can be designed such that the precursor SAW generated at the surface of the substrate be transmitted as a volume acoustic wave in the support up to reach the fluid medium and the object.

Preferably, in case the support is made of an isotropic material, the pattern of electrodes is such that the degeneration of the precursor SAW generated by the transducer at the interface between the substrate and the support achieves a volume acoustic wave with an associated radiation pressure which concentrates as a focused wave in a focalization volume represented as a square 365 in the fluid medium. The focalization volume is preferably located perpendicularly to the substrate and overlaps the center of the central zone of the precursor SAW transducer. An object located in the vicinity of said volume in the fluid medium and having a size comparable to the wavelength of the precursor SAW, also named “3D trap” is submitted to attraction forces which aims at entrapping said object in the volume. Notably, any displacement in the 3D trap is limited, in all the three space dimensions.

In a variant represented in FIG. 15, the tracks of the electrodes can be disposed on a face 370 of the substrate which is opposite to the face 375 facing the support. Preferably, in the embodiment of FIG. 15, the precursor wave is either a Lamb wave or a bulk wave.

In case it is a Lamb wave, the thickness of the substrate is lower than λ2, λ being the fundamental wavelength of the precursor SAW. This solution requires thinner substrates as the frequency increases.

Notably when the Lamb frequency would yield too thin a substrate, for instance of thickness of less than 200 μm, the volume acoustic wave can be directly generated in a thicker substrate. It can be either a bulk longitudinal acoustic wave or a bulk shear acoustic wave radiating in the thickness of the substrate at an angle depending on the anisotropy of the substrate. The step between first and second tracks of the precursor SAW transducer can be selected in order to match with the projection of the wavelength.

Advantageously, in the embodiment of FIG. 15, the transducers are protected from any damage by the support and from any pollution caused by the coupling fluid. Furthermore, the face of the substrate which is contact with the support can be easily cleaned without any risk of damaging the electrodes, when the support is removed from the substrate. A device having tracks provided on the face opposite to the support as in FIG. 15 can comprise a coupling fluid having a high dielectric constant, such as a water based gel, without the coupling fluid influencing negatively the precursor SAW generation and propagation.

Furthermore, the electrical connections, such as contact brushes can be provided on the same side as the tracks, which simplifies the manufacturing of the device, and makes it more ergonomic to the user.

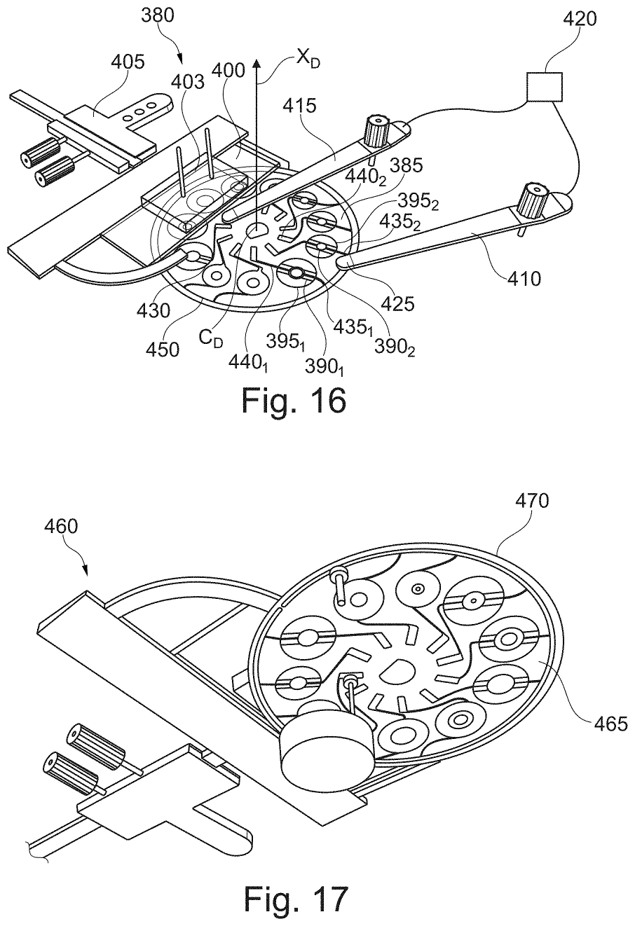

FIG. 16 describes a variant of the electroacoustic device 380 according to the first aspect of the invention which comprises a substrate 385, which is disk shaped of center CD. The substrate comprises a plurality of electrode patterns 390₁, 390₂ provided on the substrate defining a plurality of precursor SAW transducers 395₁, 395₂ and if appropriate swirling SAW transducers. Preferably, as illustrated, the precursor SAW and/or swirling SAW transducers are regularly provided around the center of the disk.

The electroacoustic device further comprises a support 400 which is preferably non opaque, and more preferably transparent. The support partially overlaps the substrate. The support and the precursor SAW and/or swirling SAW transducers are provided such that in at least one position of the device, at least one of said transducers is entirely overlapped by the support. Preferably, as illustrated in FIG. 16, the tracks are provided on the face of the substrate that is intended to face the support.

A cover 403 is disposed on the support.

The substrate is provided rotatable around a pivot axis X_{D} passing through the center CD of the disk. In particular, the electroacoustic device is configured such that, by rotating the substrate around axis XD, each precursor SAW and if appropriate swirling SAW transducer among the plurality of transducers can be positioned such as to be overlapped by the support and, notably by an object to be manipulated provided on the support.

Moreover, as illustrated, the electroacoustic device can comprise a micro-manipulator 405, connected to the support, which allows for a precise positioning by translation of the support relative to a transducer, preferably along two perpendicular axes preferably parallel to the substrate. The micro-manipulator can be fixed to an optical device such as a microscope.

Furthermore, the electroacoustic device comprises outer 410 and inner 415 contact brushes for electrically powering the electrodes. It can also comprise a power supply device 420 to which the contact brushes can be electrically connected. Preferably, the ends 425, 430 of the contact brushes intended for contacting the electrodes can be fixed with regard to the substrate. In particular, they can be provided at a constant polar coordinate relative to the center of the substrate.

Each electrode of the plurality comprises a first 435₁, 435₂ and second 440₁, 440₂ power terminal. All the power terminals of the electrodes of a same polarity are preferably provided radially on a same side of each transducer. As illustrated in FIG. 16, the power terminals of the respective first and second electrodes of the transducers are respectively radially outside and inside of the tracks of the electrode. In addition, all power terminals of the first electrodes are electrically connected to a common power track 450, which extends, preferably around a circle, at the periphery of the substrate.

The outer contact brushes are preferably in contact with the external track. By the way, when the user of the device rotates the substrate such as to place a specific transducer such as it faces the support, the electrical contact between the first electrode and the outer contact brush of said transducer is achieved with no move of the outer contact brush.

Preferably, each of the second power terminals of one of the transducers is provided such that, when the substrate is rotated around the axis X_{D} in order that the transducer faces the support, the second power terminals is in electrical contact with the inner contact brush.

Advantageously, the electroacoustic device illustrated in FIG. 16 requires a single power supply device and a single contact brushes pair to successively power each transducer. It does not require any complex control system with expensive electronic devices and is therefore cheaper than electroacoustic devices of the prior art. In addition, as described here above, manufacturing of the electrical device comprising several transducers can be performed by photolithography which is substantially inexpensive, for instance with the mask 126 as illustrated in FIG. 20.

Furthermore, the device is easy to use, since the user can select any transducer of the device by a simple rotation operation. Besides, as it can be observed on FIG. 16, each transducer is visible by the user which facilitates its initial positioning prior to manipulation of an object.

As a matter of illustration, FIG. 17 shows an electroacoustic device 460 which differs from the one of FIG. 16 by the fact that the electrode tracks are disposed on the face 465 of the substrate 470 opposite to the one that faces the support, as already illustrated in FIG. 15.

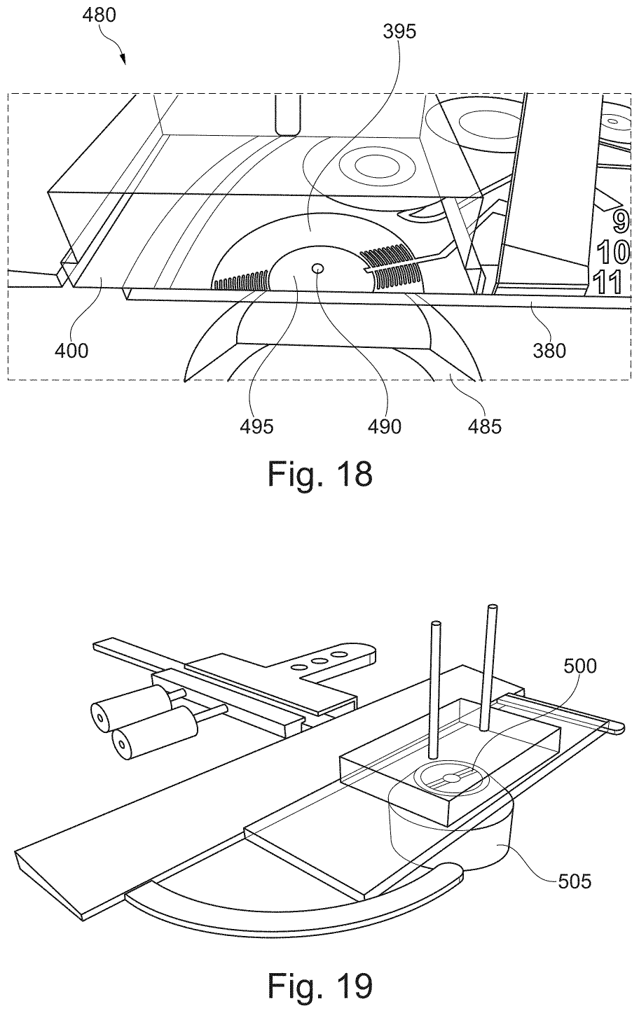

FIG. 18 shows a crop of a microscope 480 comprising the electroacoustic device 380 of FIG. 16. The electroacoustic device is fixed onto the microscope deck, such that a zone of the support, on which an object to be manipulated is disposed, overlaps an objective 485 of the microscope.

The optical device allows observation of an object 490 trapped in the central zone 495 while being manipulated by the electroacoustic device.

In the variant of FIG. 19, the transducer 500 of the electrical device of the invention is disposed on an objective 505 of the optical device. As objective magnification is directly related to the size of the object intended to be manipulated, the transducer disposed on the objective is preferably adapted to manipulate an object which can be entirely observed with the objective. Preferably, a single transducer is disposed on the objective.

The transducer can be provided on the outer lens, notably the protection lens of the objective. It can also be provided in an inner lens of the objective. Preferably, the substrate of the electrical device is in the form of a coating made of a piezoelectric material (such as AlN, ZnO) deposited on the objective, preferably having a thickness related to the frequency used by the electrical device to optimize the generation efficiency, on top of which electrodes are disposed, preferably being deposited by photolithography. The objective may comprise means for powering the transducer.

In a variant, the substrate can be disposed on a base which is configured to be fixed to the lens. The base can comprise a part made of a non-opaque, preferably transparent material on which the substrate is deposited as a layer.

Preferably, a coupling fluid is sandwiched in between the objective and the support.

In the embodiment of FIG. 19, a precursor SAW generated by the transducer can be propagated, and be transmitted as a volume acoustic wave for instance through an immersion oil wherein the lenses of the objective are embedded.

The embodiment as exemplified in FIG. 19 makes the optical device more compact and manipulation of the object is made easier. Further, it reduces issues related to light propagation which might be encountered in substrates having a thickness of greater than 1 mm.

Furthermore, the optical device can comprise a plurality of objectives, each objective comprising an electroacoustic device according to the invention, the electroacoustic devices being different the ones from the other. Preferably, each transducer has a pattern of electrodes which differs from the pattern of electrodes of at least, preferably all the transducers of the plurality. For instance, it is thus possible to successively change the objective of the plurality such as to trap an object in respectively smaller and smaller traps.

The electroacoustic device, for example comprised in an optical device such as the microscope as illustrated in FIG. 19, might be used, for instance, as follow:

A user can dispose a fluid medium comprising an object on top of the support. Then, he may firstly position the fluid medium as to be overlapped by the field of view of the objective, for instance by translating the support with the micro-manipulator.

Then he might choose the transducer which is adapted for the intended object manipulation, for instance chosen among displacement, mixing, coalescing and aliquoting. As described previously, the fundamental frequency of a precursor SAW is defined by the electrode patterns of the transducer. A man skilled in the art knows how to choose an appropriate frequency depending on the size of the object to be manipulated.

The user might then rotate the substrate such that the object and the support overlap the chosen transducer. With the micro-manipulator, the user might then position a visual marker 515 indicating the position of the center of the transducer, such as illustrated for instance in FIG. 12, with regard to the support and the object. The visual marker also preferably corresponds to the position of the bright sport of the volume acoustic SAW, on top of which the object is to be entrapped.

Then, by powering the transducer, and generating a precursor SAW which is transmitted and propagates as volume acoustic wave in the support up into the fluid medium wherein it becomes focused, the object is manipulated, displaced and trapped on top of the bright spot.

### EXAMPLE 1

### Cell Manipulation

Manipulating of cells and droplets are performed with the microscope as illustrated in FIG. 19, such as to create homogeneous or heterogeneous networks of cells such as stem cell niche, made of stem cells having similar physical properties.

Droplets are the basis of droplet-based microfluidics, used in the domain of single-cell biology. The electroacoustic device of the invention allows an in-depth study of rare events by sampling them within a large pool of experiments, currently a major issue of cancer and drug resistance research.

In this view, a central zone of a transducer is placed under a set of particles to be manipulated by displacement provided by the micro-manipulator. When a particle is at the center of the central zone of the transducer, the power supply is turned on to generate a precursor SAW in order to submit the particle to the attraction effect of the bright spot of the focused volume acoustic wave. Operating is performed with a precursor SAW having a frequency of 30 MHz, and with voltage amplitude of 5 Vpp, which are enough such to entrap 10 μm sized particles.

Then the support is moved by translation provided by the micromanipulator while the trap, i.e. the position of the particle relative to the center of the transducer, remains fixed in space, whereas the other particles which are remote from the trap follow the support translation.

Once the selected object is moved, electrical power is turned off

Then the procedure is repeated for displacing another particle such as to gather particles in a predefined pattern.

The trapping force is proportional to the acoustic power and is inversely proportional to the wavelength. It is also stronger for objects whose density and/or elasticity deviates from the fluid medium.

### EXAMPLE 2

### Cell Deformation

The electroacoustic device is also implemented to apply forces on biological cells and particles.

It is nowadays understood that forces and stress on cells may determine their fate. Somatic cells adapt to stress and may rigidify, and stem cell differentiation may be affected by external mechanical stress. Nevertheless, methods were limited to apply stress on cells.

A fluid medium comprising antibody-coated microspheres and a cell membrane is placed beneath the object to be manipulated by displacement provided by the micro-manipulator. A suitable transducer is electrically powered in order to entrap the antibody-coated microspheres on top of the center of the transducer. While electrical power is applied, the support is displaced such that the cell membrane comes into contact with the antibody-coated microspheres and is deformed by said microspheres.

Needless to say, the invention is not limited to the embodiments supplied as examples.

The present invention is also notably intended for applications in the domain of microscopy, biology, microfluidics, for lab-on-chips, for manipulating nano- and micro-systems. In biophysics, it can be used for studying the behavior of single cells such as cancer cells or stem cells, and of cells networks, for instance implied in Alzheimer illness.

1. An electroacoustic device comprising at least one precursor wave transducer comprising:
a piezoelectric substrate,
first and second electrodes of inverse polarity arranged on the substrate and configured to generate in the substrate a precursor ultrasonic surface wave which is unfocused,
wherein
when a fluid medium is acoustically coupled with the electroacoustic device, the precursor ultrasonic surface wave propagates as a volume acoustic wave into the bulk of the fluid medium and focuses therein.

2. The electroacoustic device according to claim 1, wherein the ratio of the distance separating a focalization plane where the volume acoustic wave focuses and a substrate surface on which the first and second electrodes are arranged, to a fundamental wavelength of the precursor ultrasonic surface wave is greater than 10, said distance being measured perpendicularly to the substrate surface.

3. The electroacoustic device according to claim 1, further comprising a support overlapping the substrate, acoustically coupled with the substrate, and made of at least one material different from a substrate material, such that when the fluid medium is provided on the support, the volume acoustic wave propagates in the support before reaching the fluid medium.

4. The electroacoustic device according to claim 3, wherein the support comprises a stacking of acoustically coupled layers.

5. The electroacoustic device according to claim 3, wherein the support comprises a material chosen among a glass and a polymer.

6. The electroacoustic device according to claim 3, wherein the first and second electrodes comprise respective first and second tracks, each drawing a line defined by the equation
$$R ( Θ ) = \frac{{ϕ}_{0} - ω {μ}_{0} ( Θ ) + α ( \overline{ψ} ( Θ ) ) - \frac{π}{4} sgn ( {h}^{′′} ( \overline{ψ} ( Θ ) , Θ ) )}{ω {s}_{r} ( \overline{ψ} ( Θ ) ) cos ( \overline{ψ} ( Θ ) - Θ )}$$
wherein:
R(θ) is the polar coordinate of the line, from a center C, with respect with the azimuthal angle θ,
φ₀ is a free parameter,
in particular, in order for adjacent tracks of first and second electrodes to follow different lines, different φ₀ being set, the difference between them being preferably ranging between 3.0 and 3.3, even preferably equal to π;
in particular when the electroacoustic device comprises a plurality of tracks of first and respective second electrodes, φ₀ being preferably incremented between each pair of adjacent tracks by an increment ranging between 6.0 and 6.6, preferably equal to 2π;
φ₀(θ) is given by:
$${μ}_{0} ( Θ ) = {\sum }_{i = 1}^{n} {s}_{z}^{( i )} ( Θ ) ( {z}_{i} - {z}_{i - 1} )$$
where z₀ is the height of the interface between the substrate and the support, zₙ is the height of the focal plane in the fluid medium, and zᵢ with i≥1, n>1 being the height of an interface separating two consecutive layers in case the support comprises a stacking of acoustically coupled layers, φ₀(θ)=0 in case of the absence of stacked layers
h″(ψ̅) is
$$\frac{{\partial }^{2}}{\partial {ψ}^{2}} [ {s}_{r} ( ψ ) cos ( ψ - Θ ) ]$$
evaluated at ψ=ψ̅ where ψ̅ depends on Θ as follows:
$$\overline{ψ} ( Θ ) = Θ + atan 2 ( \frac{{s}_{r}^{′} ( Θ )}{\sqrt{{s}_{r}^{′} ( Θ ) + {s}_{r}^{2} ( Θ )}} , \frac{{s}_{r} ( Θ )}{\sqrt{{s}_{r}^{{′}^{2}} ( Θ ) + {s}_{r}^{2} ( Θ )}} )$$
sᵣ(ψ) is the wave slowness on the surface plane of the substrate in the direction of propagation ψ, and s_{z}(ψ) is the wave slowness in the out of plane direction, a wave slowness in a direction i being r or z being computed from the wavenumber kᵢ as sᵣ(ψ)=kᵣ(ψ)/ω: and s_{z}(ψ)=kᵣ(ψ)/ω
sᵣ ′(ψ) is the derivative of sᵣ(ψ) in respect to the direction of propagation,
α(ψ) is the phase of the vertical motion of the wave propagating in direction w versus the associated electric field.

7. The electroacoustic device according to claim 1, wherein the first and second electrodes comprise a plurality of respective first and second tracks.

8. The electroacoustic device according to claim 1 wherein the at least one precursor wave transducer is interdigitated.

9. The electroacoustic device according to claim 3 wherein the electrodes of the at least one precursor wave transducer are sandwiched in between the substrate and the support, or at least a part of the substrate is sandwiched in between the support and the electrodes of the at least one precursor wave transducer.

10. The electroacoustic device according to claim 1 comprising a second precursor wave transducer which respective first and second electrodes are arranged on the same substrate as the first and second electrodes of the at least one precursor wave transducer, the at least one and second precursor wave transducers being configured for generating in the substrate respective precursor ultrasonic surface waves having different respective fundamental wavelengths.

11. The electroacoustic device according to claim 10, comprising contact brushes in contact with and powering the respective at least one and second precursor wave transducers, in respective first and second arrangements of the device.

12. The electroacoustic device according to claim 10, wherein the at least one precursor wave transducer at least partially surrounds the second precursor wave transducer.

13. The electroacoustic device according to claim 1 further comprising a swirling wave transducer having electrodes of inverse polarity comprising respective tracks provided on the substrate, the tracks spiraling around a same center, and being configured for generating a swirling ultrasonic surface wave in the substrate.

14. The electroacoustic device according to claim 13, wherein among the group consisting of the swirling wave transducer and the at least one precursor wave transducer, one transducer of said group surrounds at least one of the other transducers of said group.

15. An optical device, comprising the electroacoustic device according to claim 1.

16. A method for manipulating at least one object in a fluid medium, comprising:
generating a precursor surface acoustic wave with an electroacoustic device according to claim 1 and
propagating a volume acoustic wave induced by the precursor surface acoustic wave into the fluid medium and focusing said volume acoustic wave therein for creating therein a radiation pressure to which said object is submitted, and manipulating the object through displacement of the precursor wave transducer of the electroacoustic device relative to the fluid medium.

17. The method according to claim 16, wherein one or more of the object and fluid medium densities are different, or the the object and fluid medium rigidities are different.

18. The method according to claim 16, comprising propagating the volume acoustic wave throughout the bulk of a solid support before it the volume acoustic wave reaches the fluid medium.

19. An electroacoustic device comprising
a piezoelectric substrate,
at least two electrodes of inverse polarity arranged on the substrate and defining with the substrate a swirling wave transducer, the at least two electrodes comprising respective tracks spiraling around a same center, and being configured for generating a swirling ultrasonic surface wave in the substrate,
at least two further electrodes of inverse polarity arranged on the substrate and defining with the substrate a precursor wave transducer, the at least two further electrodes being configured to generate in the substrate a precursor ultrasonic wave which is unfocused and is different form the swirling ultrasonic surface wave.
